(19) United States
(12) Patent Application Publication
(10) Pub. No.: US 2008/0048417 A1
(43) Pub. Date: Feb. 28, 2008

(54) Amphibious utility cart and transport system incorporating same

(76) Inventor: Jeffrey M. Schroeder, Buffalo Grove, IL (US)

Correspondence Address: Charles F. Meroni, Jr., P.O. Box 309, Barrington, IL, 60011, US

(21) Appl. No.: 11/510,392

(22) Filed: Aug. 25, 2006

(51) Int. Cl. B62B 5/00

(52) U.S. Cl. 280/656

(57) ABSTRACT

An amphibious utility cart aids an outdoorsman in transporting equipment from home to a hunting site, and may further provide seating. The apparatus comprises framing to which a molded plastic platform is attached. The entire unit is designed to be rolled on land with wheels and to float on water with the buoyant seat platform. The platform, in a lounge chair design, is used as an equipment tote platform while going to a destination, and then as a chair for an outdoorsman or his dog when at the destination. The chair is designed for maximum floatation for water crossings and shallow-water seating. The two wheels provide the rear seating base and two retractable poles extend downward to provide frontal leg braces for a stable seating base. A handle is extended for the cart for either land or water transportation, and slides into the metal frame while in the chair mode.

### BACKGROUND OF THE INVENTION

1. Field of the Invention

The present invention generally relates to a utility cart. More particularly, the present invention relates to a multi-functional cart for transporting game or equipment with an integrated chair and retractable protective cover for concealment or weather protection capable of floating a heavy load in open water.

2. Description of the Prior Art

With the preponderance of outdoor equipment designed to improve the success, comfort and safety of the outdoorsman, a means of transporting this valued equipment afield safely and without discomfort has created a need for an aging sportsman group to easily tote belongings to the often more remote areas desired for successful hunting or fishing or other outdoor activity. This is particularly so in wooded, sandy, swampy or water environments. It is quite desirable to have a cart, chair and blind available in wooded or desolate areas, and while carts, chairs and blinds are certainly known, the presently available devices are generally designed for a single purpose, are difficult to transport, do not protect equipment from the elements and are not easily transported across, or able to be set up in, water environments. Also, transporting these items in typical automobiles is, at best, difficult due to interior space constraints.

The following prior art disclosures describe and illustrate a number of carts designed to carry loads for hunters, and some serve multiple functions after the operator performs manual conversions or alterations to the cart. None offer all the features of the present invention, and some of the features of the present invention are not offered in any of the prior art.

U.S. Pat. No. 5,375,905 ('905 patent), which issued to Flitter et al., discloses a Portable Ground Platform Seat. The '905 patent teaches a portable ground platform seat for supporting a user above a ground surface. The apparatus includes a platform member supported upon a plurality of adjustable pedestals that provides an area upon which a hunter or the like may quietly move upon and further provides an insulating barrier between the hunter and a frozen ground surface. A folding seat assembly is pivotally secured to the platform member and may be erected to provide seating for the user. In addition, the platform seat further includes a plurality of platform cavities into which a plurality of support posts may be positioned that are each operable to support a rifle, a fishing pole, or the like. The apparatus is constructed of a foam core covered by a rugged exterior skin to provide a light-weight assembly which may be easily carried by the user.

U.S. Pat. No. 5,390,839 ('839 patent), which issued to Peters, discloses a Combination Decoy Carrier and Dog Stand. The '839 patent teaches a lightweight combination duck decoy carrier and dog stand. The dog stand is a rectangular platform made of tubular aluminum with plastic webbing across it. Unfolding from the horizontal frame are four legs also made of tubular aluminum. Each pair of legs has a cross support. Also attached to the frame is a lightweight duck decoy net and a shoulder harness. The device may conveniently carry decoys through the wilderness in its folded up position by means of the shoulder harness. Once at the hunting sight, the device is deployed by unfolding the legs and sticking the ends of the legs into the ground. The dog stand is then about three feet from the mud or water level.

U.S. Pat. No. 5,692,761 ('761 patent), which issued to Havlovitz, discloses a Utility Cart. The '761 patent teaches a large bucket-like utility cart having two pairs of wheels for allowing the cart to be tilted in both a forward and backward directions on respective pairs of wheels by means of a collapsible loop handle with an angled crossbar design. A number of such utility carts can be alternately stacked or nested within one another with either the handle extended for use or collapsed or folded to its inoperative position, thus creating a high-density multiple module suitable for shipping, storage or display.

U.S. Pat. No. 5,704,624 ('624 patent), which issued to Shaw, discloses a Scuba Gear Cart having Multi-Transport Surfaces. The '624 Patent teaches an improved cart for transporting objects, particularly scuba diving equipment, over different surfaces such as asphalt and sand. The cart includes a two portion housing, one portion of which is constructed as a hull-like member which is removably mountable to a second portion constructed as a platform adapted to retain the equipment. A surface of the platform is provided with a roller system. The cart can be inverted to bring either the hull or the roller system into contact with the underlying surface over which the cart is to be transported to facilitate movement of the cart along the particular composition of underlying surface.

U.S. Pat. No. 6,139,029 ('029 patent), which issued to Shaw, discloses a Portable Utility Cart. The '029 patent teaches a multipurpose two-wheeled cart whose wheels are removable from the body of the cart to leave a generally planar flat bottom, so that the cart can be used as a sled. Side extensions may be mounted to hold bulky loads. Removable handles are provided at both of the sloping ends of the body and are adjustable to keep grips at the same height from the ground when the wheels are removed. Either or both of the handles may be mounted and used, depending on whether terrain and load make it desirable for one person or two people to move the cart and its load. The handles, wheels, and side extensions all fit within the body to provide a compact unit for transport in a motor vehicle. Stiffeners on the bottom of the body may be used as runners.

U.S. Pat. No. 6,561,529 ('529 patent), which issued to Darling, III, discloses a Versatile Portable Cart. The '529 patent teaches multi-purpose, collapsible portable cart, for use in camping, hunting and other outdoors activities carries medical rescue carts, canoes, small boats, game, or hauled cargo by hand. The portable cart can be converted to a various uses and the portable cart can be folded down and transported within a backpack, hand carried bag, canoe or boat. It transports injured persons or cargo over long, rough terrain and it can broken down into a carrying position, by hand or by back. Its width can be varied to accommodate cargo of varying widths. Two or four wheeled versions can be assembled with axles and wheels. The cart has optional removable clamps for clamping a conventional transportable carrier, such as a stretcher or stokes-type rescue carrier bed, thereto. The objects being carried can be held by clamps, by fasteners, or through the use of insertions with longitudinally extending channels. An optional pivotable kickstand and/or tie rods can stabilize the cart in a position of rest. It is collapsible, so that it can be disassembled and carried, and then reassembled at another destination along a wilderness journey.

U.S. Pat. No. 6,626,453 ('453 patent), which issued to Theus, et al., discloses a Rolling Cart for Transporting Beach Items. The '453 patent teaches a rolling cart suitable for receiving and transporting a variety of items over loose ground, such as the sand of a beach. The rolling cart includes a pair of large ring wheels that exhibit a large footprint for easy movement over and through sand, and is characterized by a high center of gravity to facilitate handling. Disposed between the wheels is a basket assembly that mounts plural rollers which cooperate with the inner wall of the wheels to maintain a generally fixed orientation during movement of the wheels.

U.S. Pat. No. 6,824,150 ('150 patent), which issued to Simione, discloses a Cart for Transport of Personnel and Material in a Hazardous Environment. The '150 Patent teaches a cart for the transportation of personnel and equipment in a fire or other hazardous environment. The cart is constructed out of fire protective material and designed to float. There are wheels on the bottom surface, which are placed and designed to be able to be operative over very uneven surfaces. The structure also has the ability to store fire equipment and in addition on the top surface a fully dressed firefighter with a Scott Air Pack. The cart has handles, which can be adjusted so as to be folded into different locked positions based on the particular usage conditions.

Prior single- and dual-function hunting carts, such as those heretofore described, have had many disadvantages for today's hunter. Transportation from home to field is difficult as they consume much interior space of an automobile. Additionally, previous carts have unprotected space between the wheels and frame body that can catch on brush or small trees. These exposed wheels also tend to rub on objects or game being transported on the cart. Additionally, narrow carts are not as stable under load as a wide-wheelbase cart. Additionally, previous carts are difficult to traverse streams or other open water under load without water damage to carried equipment. Additionally, the carts do not provide comfortable seating for the outdoorsman in a land or water environment. Additionally, these carts do not provide adequate hunter concealment from wary game or adverse weather. While various features are contemplated by other patents individually, each having corresponding advantages, they each are limited as each is designed only for a particular application. Therefore, an outdoorsman would need to own a number of specific-function carts or seats or blinds to fulfill each of the many different hunting conditions and environments that he may encounter while hunting various species of game and fowl. Prior art is generally specifically designed for hunting activities and not practically useful for other outdoor activities.

### SUMMARY OF THE INVENTION

Accordingly, the prior art perceives a need for a multi-functional cart which may be easily transported from the home to the ultimate outdoors hunting or fishing site, serves multiple functions while in the field or marsh, protects the outdoorsman's valued equipment, and effectively conceals the outdoorsman while affording maximum comfort. The overriding objective of the present invention is to provide a single apparatus for outdoorsman to use which performs multiple tasks with minimal mechanical configuration adjustments. A principle object of the present invention is to provide a wheeled cart for transporting larger items, such as sacks of decoys, firearms, game carcasses, fishing equipment or coolers to and from afield.

Another principle object is to provide an apparatus which can transport smaller equipment in a container that provides protection from the elements and is securely stowed. Another principal object is to provide an apparatus which can transport mechanical decoys in a secure, convenient fashion. Another principal object is to provide a cart handle that can be used to tow by hand or by bicycle. Another principal object is to provide a cart that can be converted into a three-wheel wagon for heavy loads or when more stability is required. Another principal object is to provide a floating cart that provides stable load transportation over water. Another principal object is to provide a stable seating platform for an outdoorsman on land. Another principal object is to provide a stable seating platform for an outdoorsman or dog on water. Another principal object is to provide a universally adaptable automobile trailer hitch configuration allowing the cart to be transported outside of the automobile or to an all terrain vehicle (ATV). Another principal object is to provide a means to carry bulky hunting equipment, coolers or game animals outside of the automobile. Another principal object is to provide a retractable canopy to deter weather and provide concealment for an outdoorsman or dog. Another principal object is to provide an apparatus which can be used as an ice fishing shelter.

To achieve these and other readily ascertainable objectives, the present invention provides a wheeled cart that can be transported from home to outdoor destination using an automobile's trailer hitch, allowing minimal lifting effort and using no interior auto space. The large, partially protected wheels afford the cart to carry large loads easily over vegetated or soft-soil land without snagging or sinking. The chair-hull design allows the cart to be pulled directly into water without alteration to safely float the load across creeks and marsh areas. While awaiting game or while fishing, it is imperative that sportsman remain comfortable to reduce game-spooking movement and to have a hunter concealed from game or protected from the elements. The chair-hull affords comfortable seating that functions in woodlands, swamps, or shallow-water areas. The retractable blind provides the outdoorsman protection from weather and affords concealment from game animals. In addition, the cart allows hunters of large game such as deer, turkey and geese to carry their harvest back to a campsite rather than having to drag or carry the carcass. The carcass can be transported back home while attached to the cart on the exterior of the automobile to avoid staining the car's interior.

The foregoing features and objects are achieved by providing a multipurpose outdoorsman's apparatus functional as a cart or a float for transporting equipment and game, and which can be used as a chair for an outdoorsman or his dog on land or in shallow water, while affording shelter and camouflage. The apparatus comprises an essentially rectangular frame defined by two elongated members, each of equal length and disposed parallel to one another. The frame has three longitudinally spaced cross bars secured to and extending between the elongated members, one located near the rear end of the elongated members; a second located above the axel rod; and a third somewhat offset from the front of the elongated members. Two wheels connected to the axel located under the longitudinally spaced cross bar to form a cart.

Attached to the front of the frame is a H-shaped handle that is recessed into the metal frame when not in use. To function with the handle, the handle is manually pulled from the metal frame to its full extension and raised to a 45 degree toting angle by rotating on the T-stops located on each handle end. To retract the handle, the handle is pivoted to the horizontal position and slid into the two elongated members when the unit is being used as a chair or is being transported or stored. The chair is stabilized with two retractable front legs, each adjustable for various heights when in the seating position and fully raised when the unit is being transported or toted. The adjustable legs are secured in the desired position with stay pins fitted through the leg and leg support holes. The legs are designed to also hold certain more delicate equipment that may not fit safely elsewhere in the cart, such as a hunter's mechanical decoys that have a peg attachment that can be inserted in the opening on the top of the leg post during transportation.

The apparatus also has a central frame member set parallel to the elongated members and is affixed to the central point of the cross bars. This member will accept a automotive trailer hitch clearance bar that will allow the entire cart to be transported by automobiles or all terrain vehicles without having to be towed on the unit's wheels or transported within the vehicle. This central frame also functions as the support frame for an additional third-wheel assembly that converts the cart to a more stable wagon format when toting heavier loads.

Attached to the frame is a floating platform, shaped in lounge-chair fashion with seat, seat back and two arm-rests. The chair seat is used as a storage platform for bulky hunting equipment or taken game while traveling to and from the field or marsh in either the manual towing mode or while in the trailer hitch transporting mode. The seat back is removable and adjustable, allowing the possibility for increased storage area for bulky items in the cart mode and to adjust for varying body sizes for increased seating comfort when in the chair mode.

The apparatus also has hinged, water-tight storage compartments in the armrest, where smaller or more environment-sensitive equipment may be stowed for safekeeping. There are also multiple vertical open-air storage cavities built into the back side of the unit for ease of transporting long, bulky items, such as fishing rods or firearms. Imbedded in the arm rests are round drink holder cavities and rectangular cavities for holding smaller items such as fishing lures or shotgun shell boxes.

An additional feature is the detachable, collapsible blind that has two U-shaped frames covered with various cloth material(s) to provide shelter from the elements or concealment of the outdoorsman or his dog from game. In the down position, the blind frame and material rest on the back portion of the chair. When pulled up and over the chair, a strap connected to the front-most U-shaped frame is connected to the front portion of the chair via a quick release fastener. The blind falls to the down-and-rear position when the fastener is released, thereby allowing unrestricted outdoorsman movement.

### BRIEF DESCRIPTION OF THE DRAWINGS

Other features of my invention will become more evident from a consideration of the following brief description of patent drawings:

FIGS. 1 through 10 depict static views of the multi-terrain utility cart of the present invention or specific components of the multi-terrain utility cart of the present invention.

FIGS. 21 through 31 show the multi-terrain utility cart in various practical use situations.

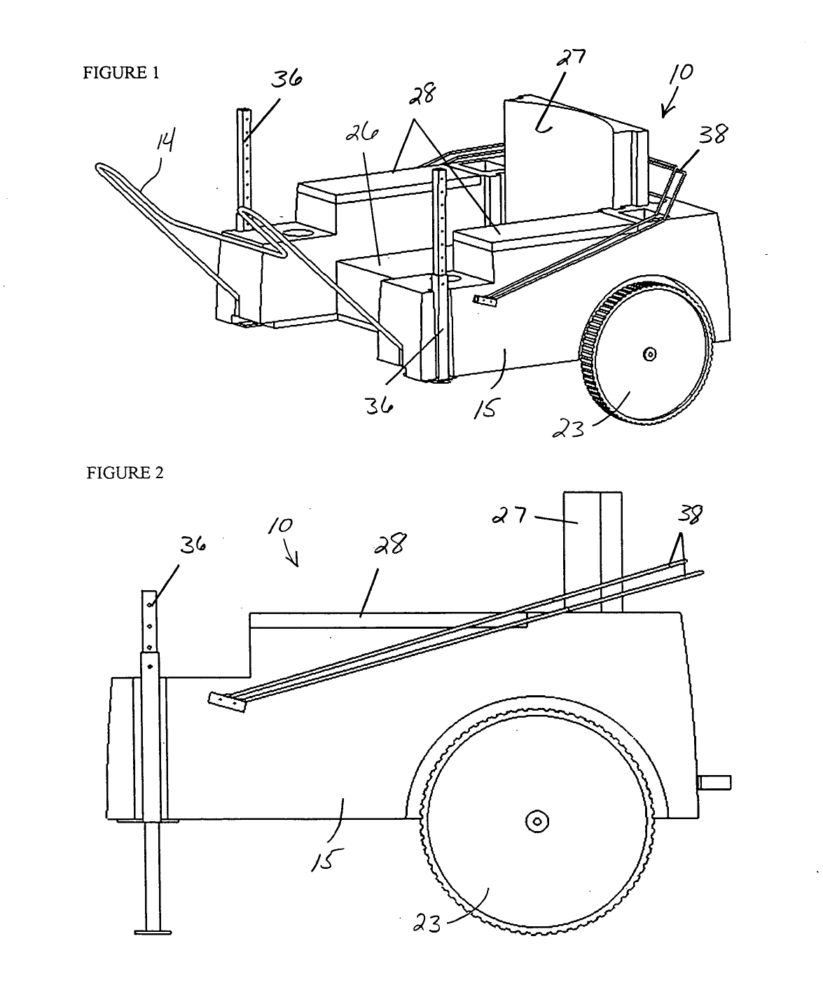

FIG. 1 is a perspective view of the multi-terrain utility cart configured for towing by hand or by bicycle while afield or traversing water.

FIG. 2 is a side view of the multi-terrain utility cart configured as a land-based or water-based chair.

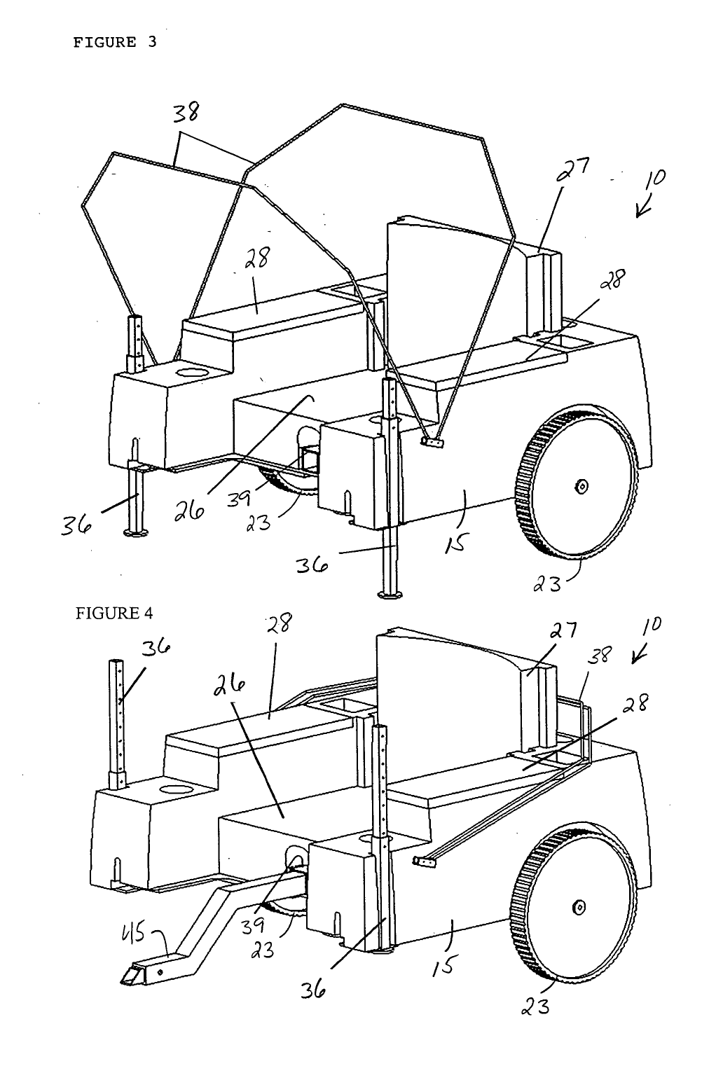

FIG. 3 is a perspective view of the embodiment multi-terrain utility cart configured with blind assembly in operational position, shown without blind material covering.

FIG. 4 is a perspective view of the embodiment multi-terrain utility cart configured for transporting by automobile or all terrain vehicle using the trailer hitch assembly.

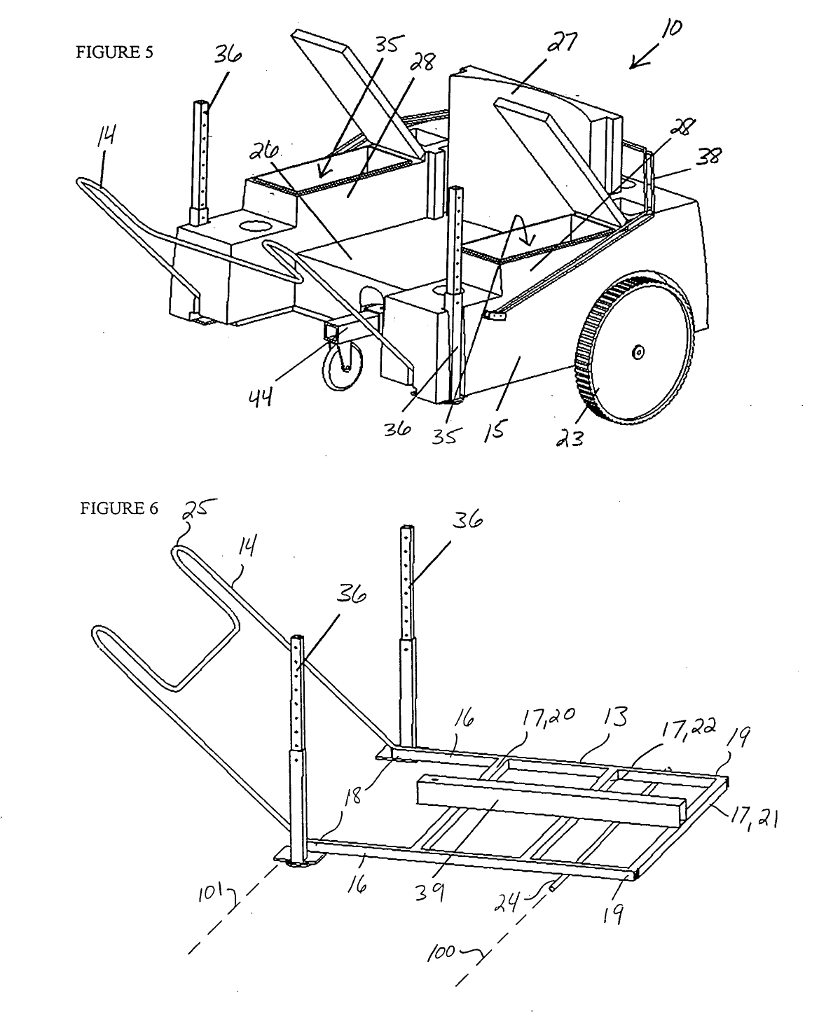

FIG. 5 is a perspective view of the embodiment multi-terrain utility cart configured as a three-wheel wagon.

FIG. 6 is a perspective view of the metal support frame and handle.

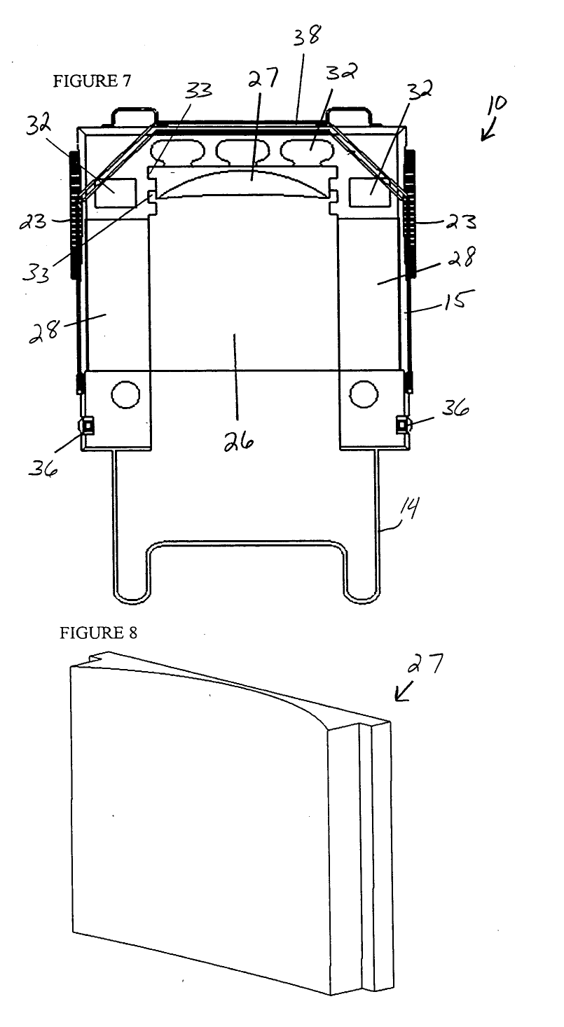

FIG. 7 is a top view of the chair.

FIG. 8 is a perspective view of the adjustable seat back.

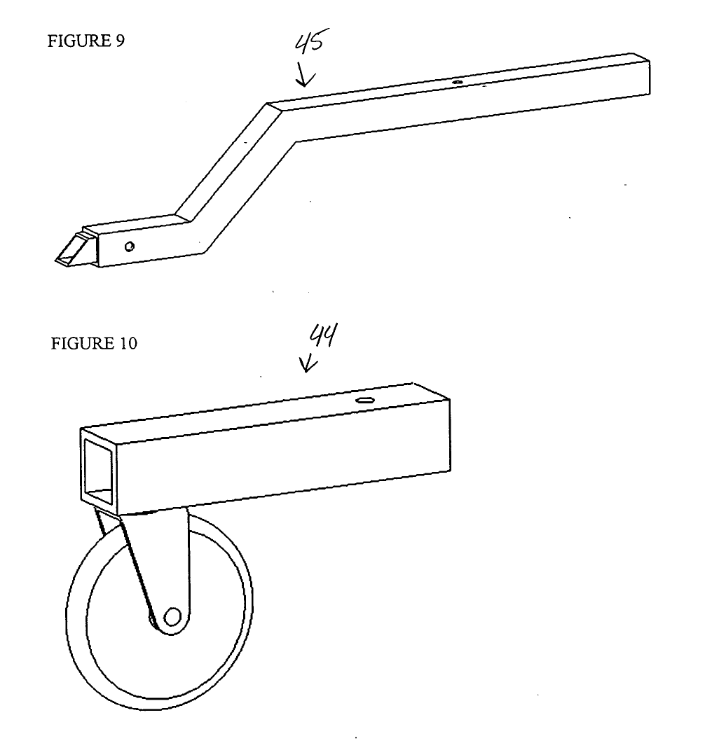

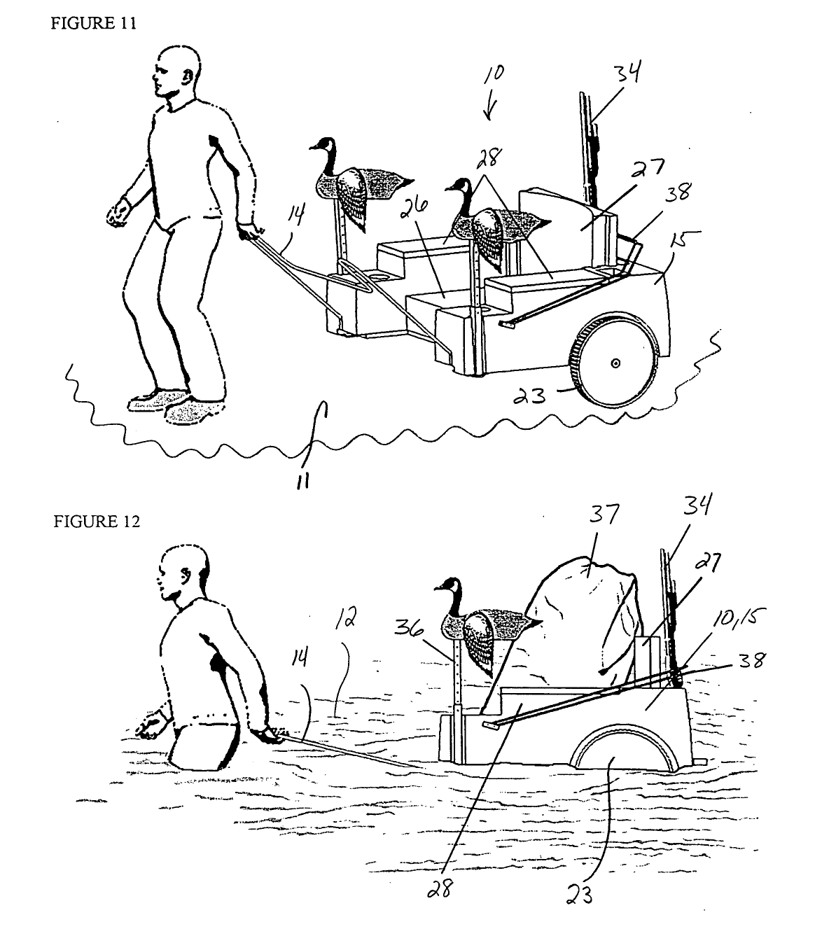

FIG. 9 is a perspective view of the trailer hitch assembly.

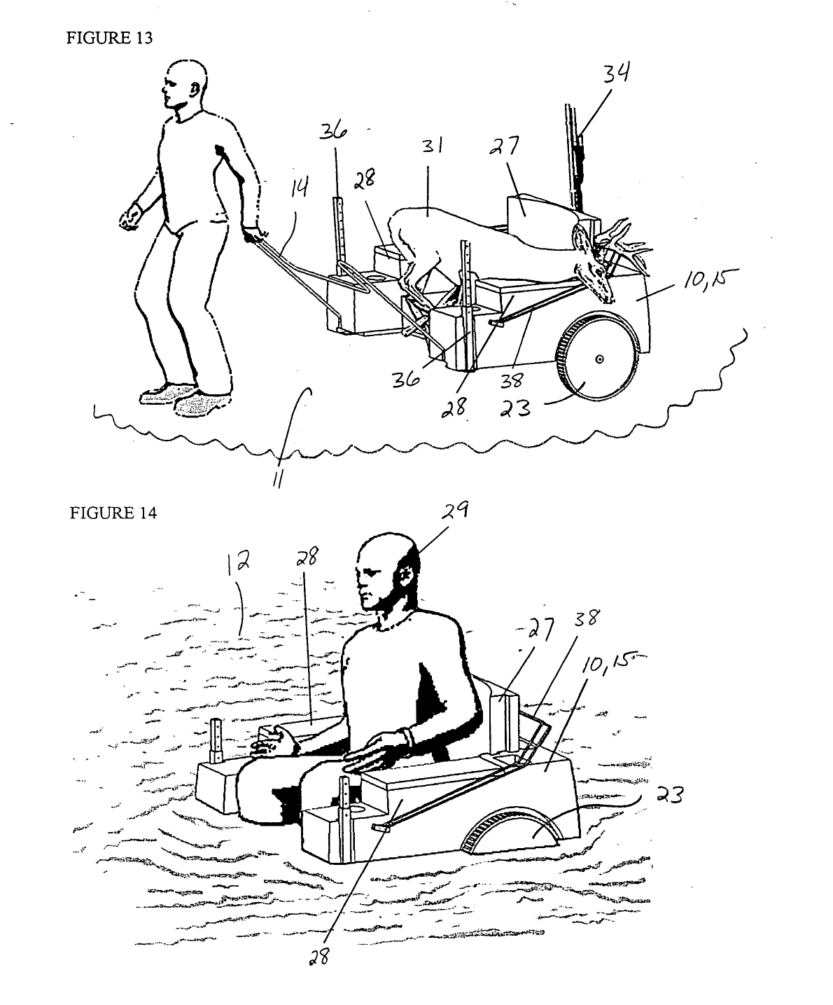

FIG. 10 is a perspective view of the third wheel assembly.

FIG. 11 depicts the multi-terrain utility cart being pulled on land in a duck hunting situation loaded with a decoy bag, spinning wing decoys, and firearms.

FIG. 12 depicts the multi-terrain utility cart being floating and pulled over water in a duck hunting situation loaded with a decoy bag, spinning wing decoys, and firearms.

FIG. 13 depicts the multi-terrain utility cart being pulled in a deer hunting situation with harvested deer in tow.

FIG. 14 depicts an outdoorsman sitting on the multi-terrain utility cart in shallow water.

FIG. 15 depicts a dog sitting on the multi-terrain utility cart in shallow water.

FIG. 16 depicts an outdoorsman sitting on the multi-terrain utility cart on a slope in the woods.

FIG. 17 depicts an outdoorsman sitting on the multi-terrain utility cart with the blind in the upright position while on a hard surface for hunting, shore fishing, ice fishing or beach situation.

FIG. 18 shows the multi-terrain utility cart being loaded by one person into the trailer hitch assembly on a truck.

FIG. 19 depicts the multi-terrain utility cart as attached for transporting with a truck using the trailer hitch assembly, depicted carrying a bag of decoys.

FIG. 20 depicts the multi-terrain utility cart being loaded by one person into the trailer hitch assembly on an all terrain vehicle.

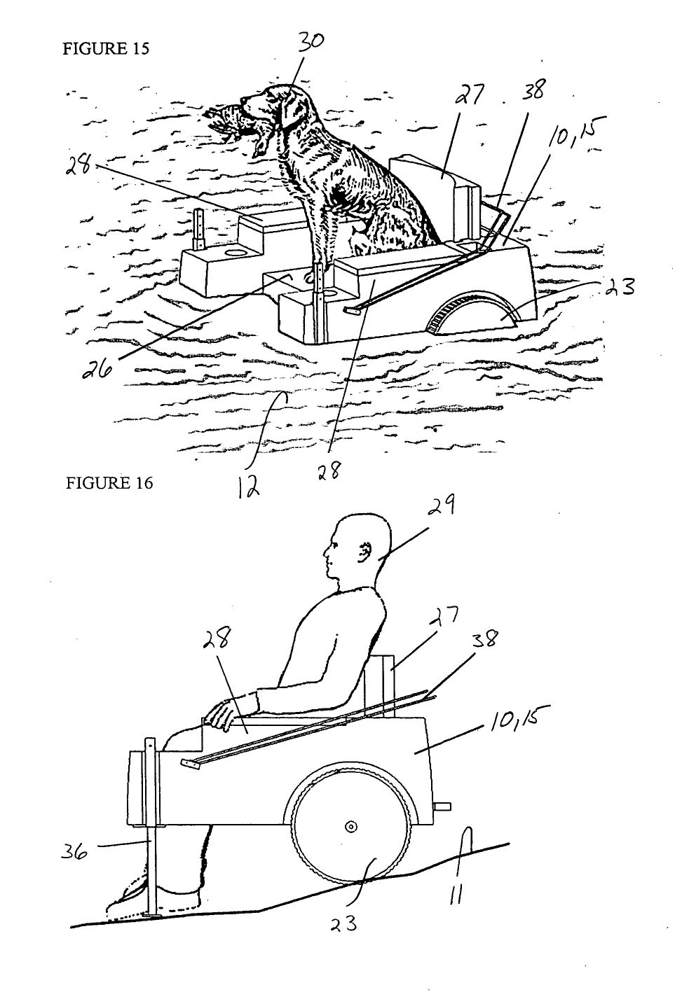

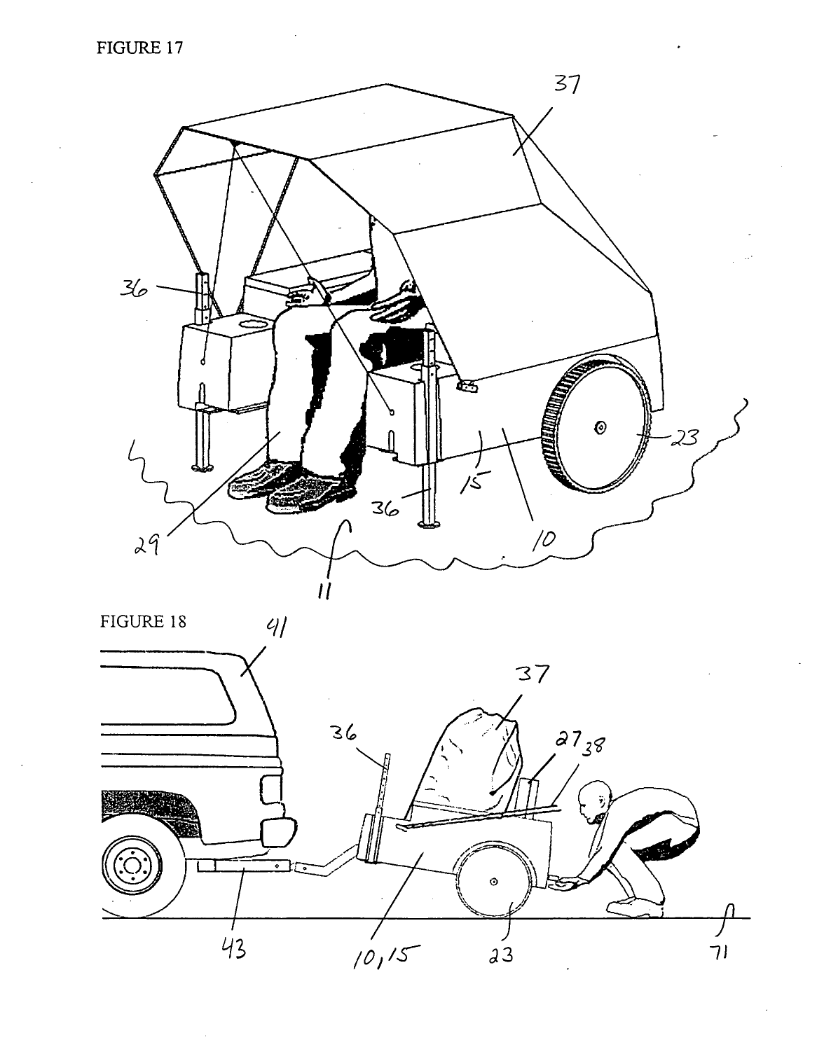

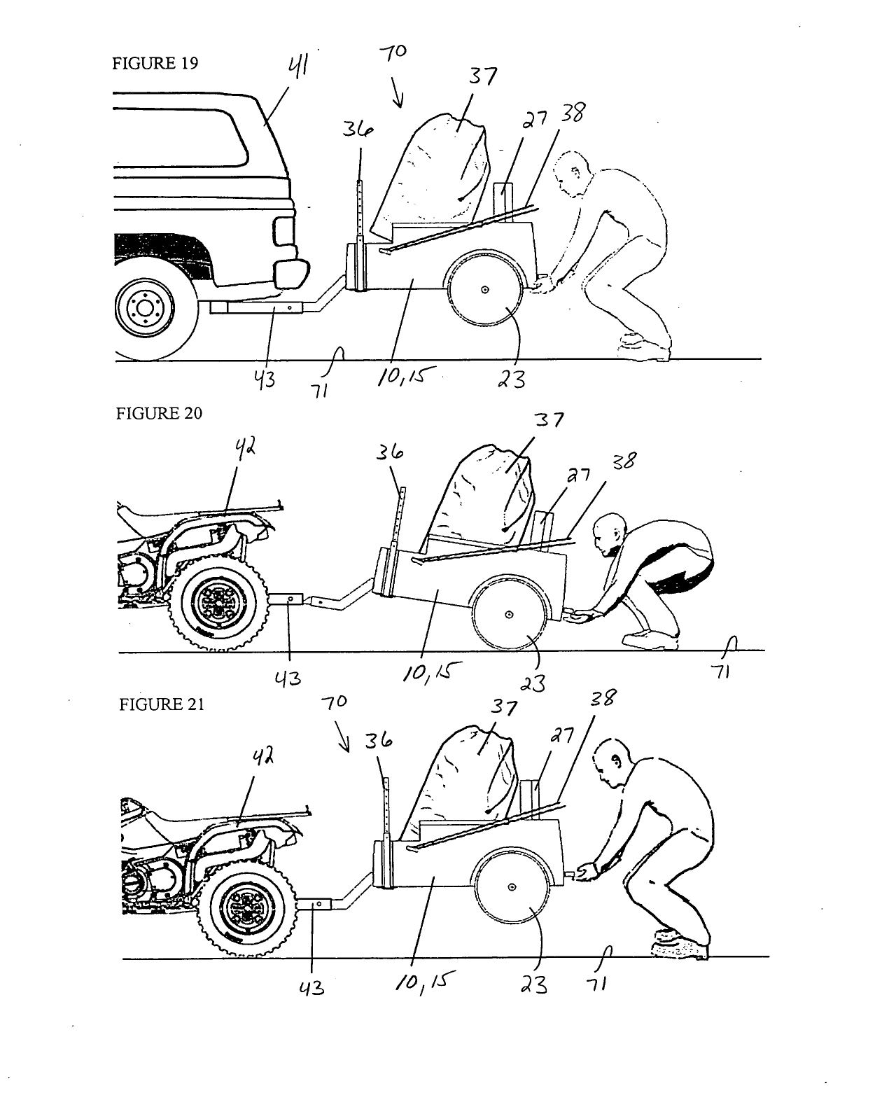

FIG. 21 depicts the multi-terrain utility cart as attached for transporting with an all terrain vehicle using the trailer hitch assembly, depicted carrying a bag of decoys.

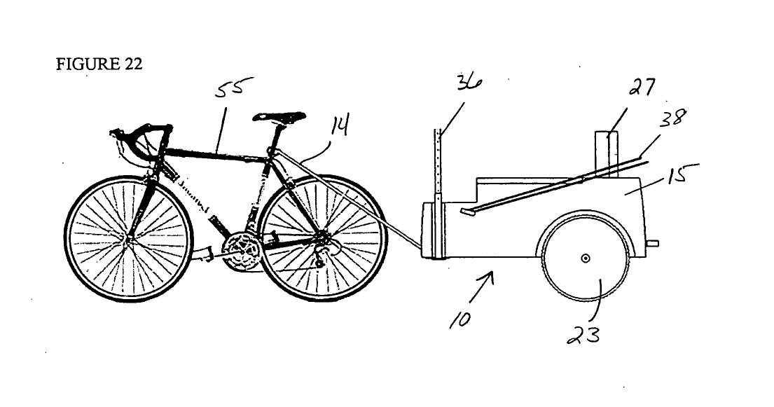

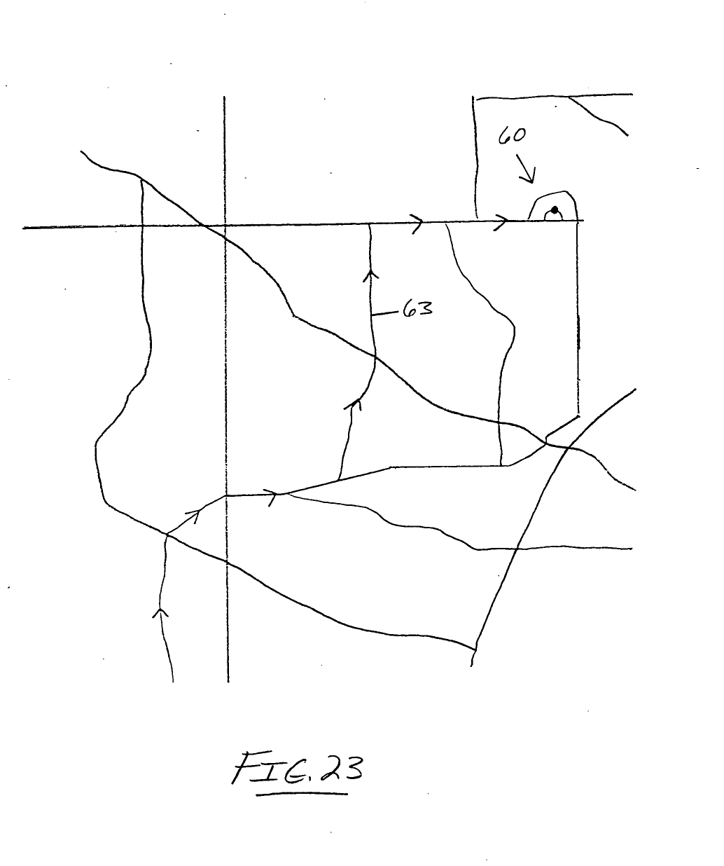

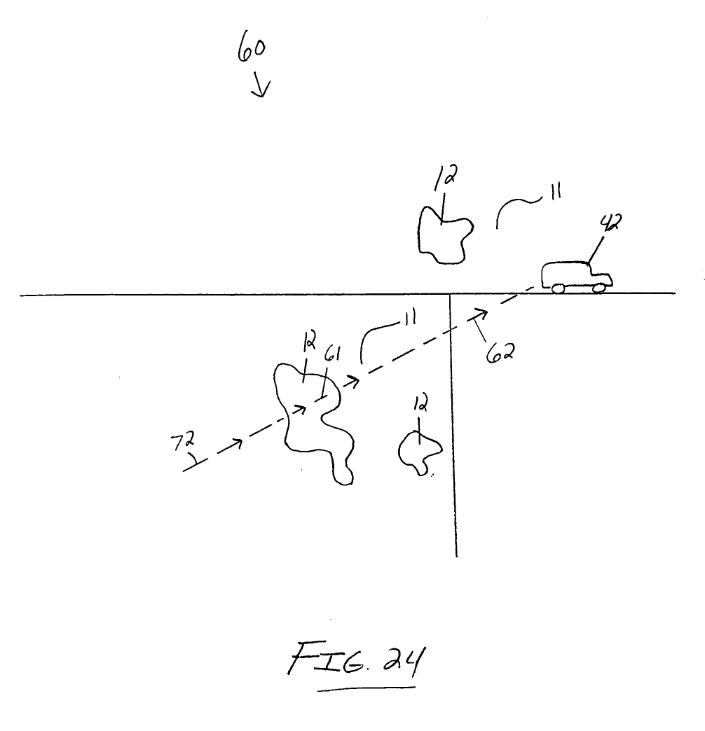

FIG. 22 depicts the multi-terrain utility cart being pulled by a bicycle.

FIG. 23 is a map of a region showing a path taken by certain cart-towing means to a hunting site.

FIG. 24 is a close-up map of the hunting site depicted in FIG. 23 showing certain bodies of water and land areas.

### DETAILED DESCRIPTION OF THE PREFERRED EMBODIMENT(S)

Referring now to the drawings with more specificity, the preferred embodiment or specification of the present invention generally concerns a multi-functional, chair-shaped cart 10 as generally illustrated and referenced in FIGS. 1-5, 7, and 11-22. It is contemplated that the cart 10 of the present invention may well function to support or transport matter (such as hunting gear, downed game, and/or hunter's themselves) over land 11 as generally depicted in FIGS. 11, 13, 16, 17, and 24; or water 12 as generally depicted in FIGS. 12, 14, 15, and 24. The cart 10 of the present invention preferably comprises a frame assembly 13 as generally illustrated and referenced in FIG. 6; a wheel assembly; a handle assembly 14 as generally illustrated and referenced in FIGS. 1, 5-7, 11-13, and 22; a foreleg assembly; and perhaps most notably, a chair-shaped support platform assembly 15 as generally illustrated and referenced in FIGS. 1-5, 7, and 11-22.

Frame assembly 13 is essentially a rectangular frame construction preferably constructed from rigid weight-bearing materials and may be preferably defined by two elongated longitudinal frame members 16 each of substantially equal or uniform length and disposed substantially parallel to one another as may be seen from a general inspection of FIG. 6. It may be seen from a further inspection of the noted figure that each frame member 16 preferably comprises a fore end 18 or forward end and an aft end 19 or a rearward end. Further, frame assembly 13 preferably comprises a series of substantially parallel lateral frame members 17 or cross bars, which members 17 are secured to and extend between each of the members 16. In this regard, it may be seen from a further inspection of FIG. 6 that the lateral frame members 17 preferably comprise a fore-member 20, an aft-member 21, and a mid-member 22. The lateral frame members 17 are preferably secured to (as for example, via welding) and extend between each longitudinal frame member 16, the aft member 21 extending intermediate or connecting the aft ends 19 of the longitudinal frame members 16, and the fore and mid-members 20 and 22 extend intermediate the fore and aft ends 18 and 19. Notably, the fore ends 18 extend outwardly from the fore member 20.

The amphibious cart 10 of the present invention may further comprise a third longitudinal frame member 39 cooperatively associated with the frame assembly 13 as generally illustrated and referenced in FIGS. 3, 4, and 6. It is contemplated that the third longitudinal frame member 39 may be preferably incorporated into the design for connecting the frame assembly 13 to peripheral structure such as the (trailer) hitch of certain cart-towing means as may be preferably defined by a sport utility vehicle 41 (generally depicted and referenced in FIGS. 18 and 19) or an all terrain vehicle 42 (generally depicted and referenced in FIGS. 20, 21, and 24).

From an inspection of FIG. 6, it may be seen that the third longitudinal frame member 39 is preferably substantially parallel with the two longitudinal frame members 16 (extending substantially equidistant therebetween) and fixedly attached to at least two of the lateral frame members 17. Thus, it is contemplated that the means for connecting the frame assembly 13 to peripheral structure may well function to connect the frame assembly 13 to select structure, the select structure being selected from the group comprising a trailer hitch assembly 43 as depicted in FIGS. 18-21 or a second wheel assembly 44 as generally depicted in FIGS. 5 and 10. It is contemplated that second wheel assembly 44 may well function to enable the user to form a tri-wheeled cart for enabling ease of transport in certain scenarios. Further, it will be seen from an inspection of FIG. 9 that certain linkage means or coupling means 45 are contemplated for coupling the cart 10 to the cart-towing means earlier identified.

Cooperatively associated with the frame assembly 13 is the wheel assembly of the present invention or similar other roller means for movement. It is contemplated, that in the preferred embodiment, the wheel assembly preferably comprises at least two wheels 23, one of which is illustrated and referenced in FIGS. 1, 2, 5, and 11-22, and both of which are illustrated and referenced in FIGS. 3, 4, and 7. Further, it is contemplated that the wheel assembly of the present invention preferably comprises certain wheel-to-frame-attachment or wheel-frame-attachment means, which may be preferably defined by an axle 24 fixedly attached (welded or bolted) to the frame assembly 13 as illustrated and referenced in FIG. 6. Notably, the wheel-frame-attachment means comprise a certain wheel axis of rotation 100 about which the wheels 23 rotate and function to attaché the wheel assembly to the frame assembly 13 adjacent the aft ends 19. The wheel axis of rotation 100 is preferably parallel to the lateral frame members 17.

The handle assembly 14 preferably comprises a tow-engagement portion 25 and certain handle-frame-attachment means, which means comprise a certain pivot axis of rotation 101 as further referenced in FIG. 6. The is pivotable about the pivot axis of rotation 101. The handle-frame-attachment means attach the handle assembly 14 to the frame assembly 13 adjacent the fore ends 18 and the pivot axis of rotation 101 is also preferably parallel to the lateral frame members 17. Essentially the handle assembly 14 enables users to pull the cart 10 either through water-based media as exemplified in FIG. 12 or over land-based media as exemplified in FIGS. 11 and 13. Preferably the tow-engagement portion 25 comprises an H-shaped handle member which recesses or telescopes into the members 16 while in the seat mode and extends to towing position by manually sliding the tow-engagement portion 25 forward. The tow-engagement portion, when pulled forward, stops and pivots via a T-stop located at the handle-frame-attachment means.

The chair-shaped support platform assembly 15 is preferably constructed from buoyant molded plastic materials and thus provides a certain buoyant platform for supporting matter in superior adjacency to a water surface as generally depicted in FIGS. 12, 14, and 15. The buoyant platform or support platform assembly 15 is preferably fixedly attached (for example, bolted) to the frame assembly 13 in superior adjacency thereto intermediate the wheels 23 and aft of the handle assembly 14. The floating platform is preferably shaped in lounge-chair fashion with a matter-support portion or seat portion 26 as illustrated and referenced in FIGS. 1, 3-5, 7, 11, and 15; a seat back portion 27 as illustrated and referenced in FIGS. 1, 2, 5, 7, 8, 11-16, and 18-22; and two arm-rests 28 as illustrated and referenced in FIGS. 1-5, 7, and 11-16.

It is contemplated that the seat portion 26 functions to supporting matter such as a person 29 as illustrated and referenced in FIGS. 14, 16, and 17; a hunting dog 30 as illustrated and referenced in FIG. 15; or downed game 31 as generally depicted and referenced in FIG. 13. Further, it is contemplated that the back portion 27 functions to prevent aft displacement of matter (such as heretofore exemplified) relative to the seat portion 26. It is further contemplated that the arm rest portions 28 may preferably comprise certain waterproof or watertight compartments 35 for compartmentalizing matter as generally illustrated and referenced in FIG. 5. The waterproof compartments 35 may well function to prevent moisture from contacting compartmentalized (moisture-sensitive) matter such as a cell phone, map, or similar other articles.

It is contemplated that the back portion 27 may be preferably removable and selectively positioned atop seat portion 26 for effecting variable seat portion space. In this regard, it will be seen from an inspection of FIG. 7 that certain vertical slots 33 are preferably formed in platform assembly 15 so as to enable the user to adjust the open matter-supporting space atop seat portion 26. Thus, it is contemplated that the platform assembly 15 preferably comprises certain back portion-adjustment means, the back portion-adjustment means for enabling the user to selectively vary the matter-supporting space atop the seat portion 26. It is further contemplated that the platform assembly may preferably comprise a plurality of vertically oriented, open-top storage cavities 32, which cavities may well function to store hunting gear 34 or other articles as generally depicted in FIG. 7 versus FIGS. 11-13.

Cart 10 may further preferably comprise a foreleg assembly, which foreleg assembly comprises two substantially parallel extendable leg assemblies 36 as illustrated and referenced in FIGS. 1-7, 12, 13, and 16-22. Each extendable leg assembly 36 preferably comprises an extendable transversely apertured leg that may be telescopically received in a leg-receiving sleeve, which sleeve may comprise aperture engaging structure (for selectively varying the telescopic nature of the leg) and certain leg-to-frame-attachment means or leg-frame-attachment means for attaching the foreleg assembly to the fore ends 18 as generally depicted in FIG. 6. It will be seen from an inspection of FIG. 6 that the leg assemblies 36 are preferably substantially orthogonal to the longitudinal frame members 16. Further, from an inspection of FIG. 16, it will be understood that the extendable leg assemblies 36 may well function to enable a user to maintain the seat portion 26 in a substantially horizontal plane when atop a variably inclined solid surface 11.

The cart 10 of the present invention may further comprise a detachable cover assembly 37 as illustrated and referenced in FIGS. 12, and 17-21. Cover assembly 37 is further shown with certain blind structure removed in FIGS. 1-5, 7, 11, 13-16, and 18-22 to show certain blind-supporting means as referenced at 38. It is contemplated that the cover assembly 37 of the present invention may be cooperatively associable with the buoyant platform assembly 15 for selectively preventing matter (such as debris or rain) and energy (such as light energy) from contacting matter (such as a person 29 or gear 34) supported by the buoyant platform assembly. In this regard, it should be noted that the cover assembly 37 may well function to provide certain blind means for concealing the user (i.e. preventing light from contacting the user) and may preferably comprise camouflage type indicia (as may platform assembly 15) for blending the cart 10 into surrounding while at a hunting site 60 as generally depicted in FIG. 24.

It is contemplated that, together, the handle assembly 14 and buoyant platform assembly 15 may well function to support (via the platform assembly) and transport (via the force-transferring handle assembly) matter (such as gear, game, and the like) in superior adjacency to a liquid surface (such as a pond or lake surface) as generally depicted in FIGS. 12, 14, 15, and 24. Further, the handle assembly 14, buoyant platform assembly 15, and the wheel assembly (defining certain roller means for movement) may well function to support and transport matter in superior adjacency to a solid surface such as surface 11 intermediate ponds or lakes as generally depicted in FIGS. 11, 13, 17, and 24. The amphibious cart 10 of the present invention thus functions for selectively transporting matter over land or water.

While the above descriptions contain much specificity, this specificity should not be construed as limitations on the scope of the invention, but rather as an exemplification of the invention. For example, the invention may be said to essentially teach or disclose an amphibious utility cart for selectively transporting matter over varied terrain, the amphibious utility cart comprising a buoyant platform assembly, certain roller means for movement, and certain linkage means for movement (such as the handle assembly 14 or hitch assemblages heretofore specified). Stated another way, the utility cart of the present invention may be said to necessarily comprise a buoyant, chair-shaped platform assembly, certain roller means for movement, and at least one extendable leg assembly, the extendable leg assembly enabling a user to maintain the seat portion in a substantially horizontal plane when atop a solid surface.

The platform assembly comprises a fore end, an aft end, and a matter-support portion, the matter-support portion for supporting matter. The roller means for movement are preferably and cooperatively associated with the aft end for enabling roller-enabled platform movement over solid surfaces. The linkage means may be preferably and cooperatively associated with a select end of the platform assembly for transferring cart-displacing forces to the utility cart (the select end being selected from the group consisting of the fore end and aft end (the cart may also be pushed)). The platform assembly, the roller means for movement, and the linkage means for movement are thus cooperable for supporting and transporting matter in superior adjacency to a transport medium (such as land or water) and the utility cart thus functions to transport matter over varied terrain.

In a further sense, the cart 10 of the present invention may be said to enable a certain hunting transport system, which system comprises a variety of cooperable components and which functions to ease transport of (hunting) gear and game. In this regard, it is contemplated that the hunting transport system of the present invention may be said to preferably comprise, in combination, certain cart-towing means (such as a bike 55 as depicted and referenced in FIG. 22 or vehicle 42); certain cart-linkage means (such as handle assembly 14 or coupling means 45), an amphibious utility cart (such as cart 10), and a hunting site 60 as generally depicted in FIGS. 23 and 24.

The cart-linkage means essentially function to link the utility cart in a suspended state to the cart-towing means. The linked utility cart is thus held in suspended superior adjacency (as referenced at 70 in FIGS. 19 and 20) to a tow-enabling surface such as a road, path or pavement 71. The cart-towing means function to tow or haul the utility cart to and from the hunting site 60. In this regard, the reader is directed to FIG. 23, which depicts a path 63 taken to a hunting site 60. The utility cart, detachable from the cart-towing means, may well function to cart gear and game within the hunting site 60 as generally depicted at vector arrow 72 in FIG. 24. It should be understood from an inspection of FIG. 24 that the hunting site 60 may comprise one or more liquid support surface(s) (as at 12) and a solid support surface (as at 11) over which the cart may be used to transport matter.

In this regard, it will be recalled that the utility cart comprises a buoyant platform assembly and roller means for movement. The platform assembly comprises a matter-support portion, the matter-support portion for supporting gear and game. The buoyant platform assembly enables supported matter movement over liquid support surfaces (as at 61 in FIG. 24); the roller means for movement enable platform movement (it being noted that the platform supports matter and matter movement) over solid support surfaces (as at 62); and the cart-towing means and cart-linkage means enable utility cart movement (it being noted that the matter support portion supports matter and matter movement, and the roller means for movement support the platform and platform movement) in suspended superior adjacency to tow-enabling surface(s). It is thus contemplated that the hunting transport system of the present invention may thus function to ease transport of gear and game.

Accordingly, although the invention has been described by reference to a number of preferred embodiments and which embodiments operate to effect a certain transport system, it is not intended that the novel system, apparatus be limited thereby, but that modifications thereof are intended to be included as falling within the broad scope and spirit of the foregoing disclosure, the following claims and the appended drawings.

I claim:

1. A multi-functional amphibious cart, the amphibious cart for selectively transporting matter over land or water, the amphibious cart comprising:
a frame assembly, the frame assembly comprising two substantially parallel longitudinal frame members and three substantially parallel lateral frame members, the longitudinal frame members each having a substantially uniform length and comprising a fore end and an aft end, the lateral frame members comprising a fore-member, an aft-member, and a mid-member, the lateral frame members being secured to and extending between each longitudinal frame member, the aft member connecting the aft ends, the fore and mid-members extending intermediate the fore and aft ends;
a wheel assembly, the wheel assembly comprising at least two wheels and wheel-frame-attachment means, the wheel-frame-attachment means comprising a wheel axis of rotation, the wheels being rotatable about the wheel axis of rotation, the wheel-frame-attachment means attaching the wheel assembly to the frame assembly adjacent the aft ends, the wheel axis of rotation being parallel to the lateral frame members;
a handle assembly, the handle assembly comprising a tow-engagement portion and handle-frame-attachment means, the handle-frame-attachment means having a pivot axis of rotation, the tow-engagement portion being pivotable about the pivot axis of rotation, the handle-frame-attachment means attaching the handle assembly to the frame assembly adjacent the fore ends, the pivot axis of rotation being parallel to the lateral frame members; and
a buoyant platform, the buoyant platform being attached to the frame assembly in superior adjacency thereto intermediate the wheels aft of the handle assembly, the handle assembly and buoyant platform for supporting and transporting matter in superior adjacency to a liquid surface, the handle assembly, buoyant platform, and wheel assembly for supporting and transporting matter in superior adjacency to a solid surface, the amphibious cart thus for selectively transporting matter over land or water.

2. The amphibious cart of claim 1 wherein the buoyant platform is chair-shaped, the chair-shaped buoyant platform comprising a seat portion and a back portion, the seat portion for supporting matter, the back portion for preventing aft displacement of matter relative to the seat portion.

3. The amphibious cart of claim 2 wherein the buoyant platform comprises a plurality of vertically-oriented open-top storage cavities.

4. The amphibious cart of claim 2 wherein the buoyant platform comprises back portion adjustment means, the back-portion adjustment means for enabling the user to selectively vary matter-supporting space atop the seat portion.

5. The amphibious cart of claim 2 wherein the buoyant platform comprises opposing arm rest portions, the arm rest portions comprising compartments for compartmentalizing matter.

6. The amphibious cart of claim 5 wherein the compartments are waterproof, the waterproof compartments for preventing moisture from contacting compartmentalized matter.

7. The amphibious cart of claim 1 comprising a foreleg assembly, the foreleg assembly comprising two substantially parallel extendable leg assemblies, each extendable leg assembly comprising an extendable leg and leg-frame-attachment means, the leg-frame-attachment means attaching the foreleg assembly to the fore ends, the leg assemblies being substantially orthogonal to the longitudinal frame members, the extendable leg assemblies enabling a user to maintain the seat portion in a substantially horizontal plane when atop a solid surface.

8. The amphibious cart of claim 1 comprising a detachable cover assembly, the cover assembly being cooperatively associable with the buoyant platform for selectively preventing matter and energy from contacting matter supported by the buoyant platform.

9. The amphibious cart of claim 1 wherein the frame assembly comprises a third longitudinal frame member, the third longitudinal frame member being substantially parallel with the two longitudinal frame members extending substantially equidistant therebetween and fixedly attached to at least two of the lateral frame members, the third longitudinal frame member comprising means for connecting the frame assembly to peripheral structure.

10. The amphibious cart of claim 9 wherein the means for connecting the frame assembly to peripheral structure function to connect the frame assembly to select structure, the select structure being selected from the group comprising a trailer hitch assembly and a second wheel assembly.

11. A chair-shaped utility cart, the utility cart for selectively transporting matter over varied terrain, the utility cart comprising:
a chair-shaped platform assembly, the platform assembly comprising a fore end, and aft end, a seat portion, and a back portion, the seat portion for supporting matter, the back portion for preventing aft displacement of matter relative to the seat portion;
a wheel assembly, the wheel assembly comprising at least two wheels and wheel-platform-attachment means, the wheel-platform-attachment means comprising a wheel axis of rotation, the wheels being rotatable about the wheel axis of rotation, the wheel-platform-attachment means attaching the wheel assembly to the platform assembly adjacent the aft end; and
a handle assembly, the handle assembly comprising a tow-engagement portion and handle-platform-attachment means, the handle-platform-attachment means having a pivot axis of rotation, the handle-platform-attachment means attaching the handle assembly to the platform assembly adjacent the fore end, the tow-engagement portion being pivotable about the pivot axis of rotation, the platform assembly, the wheel assembly, and the handle assembly for supporting and transporting matter in superior adjacency to a transport medium, the utility cart thus for transporting matter over varied terrain.

12. The utility cart of claim 11 comprising a foreleg assembly, the foreleg assembly comprising two substantially parallel extendable leg assemblies, each extendable leg assembly comprising an extendable leg and leg-platform-attachment means, the leg-platform-attachment means attaching the foreleg assembly to the fore end, the extendable leg assemblies enabling a user to maintain the seat portion in a substantially horizontal plane when atop a solid surface.

13. The utility cart of claim 11 wherein the platform assembly is buoyant, the buoyant platform assembly and the handle assembly for supporting and transporting matter in superior adjacency to a liquid transport medium, the utility cart thus for selectively transporting matter over land or water.

14. The utility cart of claim 13 wherein the platform assembly comprises a plurality of vertically-oriented open-top storage cavities.

15. The utility cart of claim 13 wherein the platform assembly comprises back portion-adjustment means, the back portion-adjustment means for enabling the user to selectively vary matter-supporting space atop the seat portion.

16. The utility cart of claim 13 wherein the platform assembly comprises opposing arm rest portions, the arm rest portions comprising compartments for compartmentalizing matter.

17. The utility cart of claim 16 wherein the compartments are waterproof, the waterproof compartments for preventing moisture from contacting compartmentalized matter.

18. The utility cart of claim 11 comprising a detachable cover assembly, the cover assembly being cooperatively associable with the platform assembly for selectively preventing matter and energy from contacting matter supported by the platform assembly.

19. The utility cart of claim 11 wherein the platform assembly comprises a longitudinal frame member fixedly attached thereto, the longitudinal frame member comprising means for connecting the platform assembly to peripheral structure.

20. The utility cart of claim 19 wherein the means for connecting the frame assembly to peripheral structure function to connect the frame assembly to select structure, the select structure being selected from the group comprising a trailer hitch assembly and a second wheel assembly.

21. An amphibious utility cart, the amphibious utility cart for selectively transporting matter over varied terrain, the amphibious utility cart comprising:
a buoyant platform assembly, the platform assembly comprising a fore end, an aft end, and a matter-support portion, the matter-support portion for supporting matter;
roller means for movement, the roller means for movement being cooperatively associated with the aft end for enabling roller-enabled platform movement over solid surfaces; and
linkage means for movement, the linkage means for movement being cooperatively associated with a select end of the platform assembly for transferring cart-displacing forces to the utility cart, the platform assembly, the roller means for movement, and the linkage means for movement being cooperable for supporting and transporting matter in superior adjacency to a transport medium, the utility cart thus for transporting matter over varied terrain.

22. The utility cart of claim 21 comprising at least one extendable leg assembly, each extendable leg assembly comprising an extendable leg and leg-platform-attachment means, the leg-platform-attachment means attaching the leg assembly to the fore end, the extendable leg assembly enabling a user to maintain the platform in a substantially horizontal plane when atop a solid surface.

23. The utility cart of claim 21 wherein the platform assembly is chair-shaped, the chair-shaped platform assembly comprising a seat portion and a back portion, the seat portion defining the matter support portion, the back portion for preventing aft displacement of matter relative to the seat portion.

24. The utility cart of claim 23 wherein the platform assembly comprises a plurality of vertically-oriented open-top storage cavities.

25. The utility cart of claim 24 wherein the platform assembly comprises back portion-adjustment means, the back portion-adjustment means for enabling the user to selectively vary matter-supporting space atop the seat portion.

26. The utility cart of claim 25 wherein the platform assembly comprises opposing arm rest portions, the arm rest portions comprising compartments for compartmentalizing matter.

27. The utility cart of claim 26 wherein at least one compartment is waterproof, each waterproof compartments for preventing moisture from contacting compartmentalized matter.

28. The utility cart of claim 21 comprising a detachable cover assembly, the cover assembly being cooperatively associable with the platform assembly for selectively preventing matter and energy from contacting matter supported by the platform assembly.

29. The utility cart of claim 21 wherein the platform assembly comprises a longitudinal frame member fixedly attached thereto, the longitudinal frame member comprising means for connecting the platform assembly to peripheral structure.

30. The utility cart of claim 29 wherein the means for connecting the frame assembly to peripheral structure function to connect the frame assembly to select structure, the select structure being selected from the group comprising a trailer hitch assembly and a second wheel assembly.

31. An amphibious utility cart, the amphibious utility cart for selectively supporting matter in variable terrain, the amphibious utility cart comprising:
a buoyant, chair-shaped platform assembly, the platform assembly comprising a fore end, an aft end, a seat portion, and a back portion, the seat portion for supporting matter;
roller means for movement, the roller means for movement being cooperatively associated with the aft end for enabling roller-enabled platform movement over solid surfaces; and
at least one extendable leg assembly, each extendable leg assembly comprising an extendable leg and leg-platform-attachment means, the leg-platform-attachment means attaching the leg assembly to the fore end, the extendable leg assembly enabling a user to maintain the seat portion in a substantially horizontal plane when atop a solid surface, the platform assembly being capable of receiving cart-displacing forces, the platform assembly, the roller means for movement and the leg assembly being cooperable for supporting matter in superior adjacency to a transport medium, the utility cart thus for supporting matter in varied terrain.

32. A hunting transport system, the hunting transport system for easing transport of gear and game, the hunting transport system comprising, in combination:
cart-towing means, cart-linkage means, an amphibious utility cart, and a hunting site, the cart-linkage means for linking the utility cart to the cart-towing means, the linked utility cart being held in suspended superior adjacency to a tow-enabling surface, the cart-towing means for towing the utility cart to and from the hunting site, the utility cart for carting gear and game within the hunting site, the hunting site comprising liquid and solid support surfaces, the utility cart comprising a buoyant platform assembly and roller means for movement, the platform assembly comprising a matter-support portion, the matter-support portion for supporting gear and game, the buoyant platform assembly for enabling supported matter movement over liquid support surfaces, the roller means for movement for enabling platform movement over solid support surfaces, the cart-towing means and cart-linkage means for enabling utility cart movement in suspended superior adjacency to tow-enabling surfaces, the hunting transport system thus for easing transport of gear and game.
